(19) United States
(12) Patent Application Publication
(10) Pub. No.: US 2025/0222692 A1
(43) Pub. Date: Jul. 10, 2025

(54) LIQUID DISCHARGING HEAD AND METHOD OF MANUFACTURING LIQUID DISCHARGING HEAD

(71) Applicant: CANON KABUSHIKI KAISHA, Tokyo (JP)

(72) Inventor: MASATAKA KATO, Kanagawa (JP)

(21) Appl. No.: 19/001,714

(22) Filed: Dec. 26, 2024

(30) Foreign Application Priority Data
Jan. 10, 2024 (JP) 2024-001728

(51) Int. Cl. B41J 2/14; B41J 2/16

(52) U.S. Cl. CPC B41J 2/14201; B41J 2/161; B41J 2002/14306; B41J 2202/22

(57) ABSTRACT

A method includes: forming a first channel for liquid having a recessed shape by dry-etching a substrate from a first surface thereof; forming a protection film by using a material different from the substrate on a bottom surface of the first channel; forming a plurality of second channels for liquid each having a recessed shape by dry-etching the substrate from a second surface thereof, so as to be connected to the bottom surface of the first channel; and opening the plurality of second channels through to the bottom surface of the first channel by removing the protection film by dry etching from a second surface side, wherein an etching rate of a material of the protection film is lower than an etching rate of a material of the substrate during the dry-etching for forming the plurality of second channels in the substrate.

### BACKGROUND OF THE INVENTION

### Field of the Invention

The present invention relates to a liquid discharging head and a method of manufacturing the liquid discharging head.

### Description of the Related Art

There is an ink jet recording apparatus that carries out recording by discharging liquid from a liquid discharging head, which has a plurality of nozzles, onto a recording medium. The liquid discharging head includes an element substrate including a plurality of pressure generation chambers, which are provided correspondingly to the plurality of nozzles respectively, and piezoelectric elements provided in the plurality of pressure generation chambers respectively. The liquid discharging head is configured to discharge from the nozzles the liquid that is in the pressure generation chambers, by driving the piezoelectric elements. The element substrate has a plurality of channels communicated with the plurality of pressure generation chambers, and a common channel connected to the plurality of channels. By supplying liquid into the common channel from external, the liquid is supplied into the pressure generation chambers. The common channel and the plurality of channels communicated therewith are formed as recessed portions by dry-etching the substrate from both surfaces of the substrate.

Japanese Patent Application Laid-open No. 2016-135583 discloses forming a plurality of channels each having a small opening by dry-etching the substrate from a first surface of the substrate, and forming a channel having a large opening communicated with the plurality of channels each having the small opening by dry etching the substrate from a second surface that is on the opposite side of the first surface.

It is assumed herein that through-holes passing through the substrate are formed by dry-etching the substrate from the first surface, to form a first channel as a recessed portion having a large opening, and then by dry-etching the substrate from the second surface, to form second channels as recessed portions each having a smaller opening, in such a manner that the plurality of second channels open the bottom surface of the first channel. In such a case, when the second channels penetrate through the bottom surface of the first channel, an etching gas having gone through the openings and crept onto the bottom surface of the first channels may roughen the bottom surface of the first channel. Such a roughness may cause contamination in the form of foreign matter as a substrate fragment becomes detached from the substrate. Furthermore, when the liquid is discharged, pools of bubbles may be formed on the rough surface of the first channel, and deteriorate the discharging function. Furthermore, when a protection film is to be disposed on the channel wall surface including the bottom of the first channel, the protection film may peel off because of the roughness.

### SUMMARY OF THE INVENTION

The present invention is configured to suppress roughness of the bottom surface of a channel at the time when forming a channel by dry-etching the substrate from both surfaces of the substrate.

The present invention is a method of manufacturing a liquid discharging head including a substrate having a channel for liquid, the method comprising:
forming a first channel having a recessed shape by dry-etching the substrate from a first surface thereof;
forming a protection film by using a material, which is different from a material of the substrate, on a bottom surface of the first channel;
forming a plurality of second channels each having a recessed shape by dry-etching the substrate from a second surface that is on an opposite side to the first surface so as to be connected to the bottom surface of the first channel; and
opening the plurality of second channels through to the bottom surface of the first channel by removing the protection film from parts of the bottom surface of the first channel, the parts being parts to which the plurality of second channels are to be connected respectively, by dry etching from a second surface side, wherein
an etching rate of a material of the protection film is lower than an etching rate of a material of the substrate during the dry-etching for forming the plurality of second channels in the substrate.

The present invention is a liquid discharging head comprising:
a substrate formed of silicon and having a first surface and a second surface on an opposite side to the first surface;
a first channel for liquid provided to the first surface of the substrate and having a recessed shape;
a plurality of second channels for liquid provided to the second surface of the substrate, each having a recessed shape, and opening to a bottom surface of the first channel; and
a protection film provided to the bottom surface of the first channel in a part not having openings of the plurality of respective second channels and formed of a material different from a material of the substrate, wherein
in relation to etching of silicon forming the substrate, an etching rate of a material of the protection film is lower than an etching rate of the silicon forming the substrate.

Further features of the present invention will become apparent from the following description of exemplary embodiments with reference to the attached drawings.

### BRIEF DESCRIPTION OF THE DRAWINGS

FIG. 1 is a sectional view illustrating a liquid discharging head manufactured in a first embodiment;

FIGS. 2A to 2G are schematic process diagrams for explaining the first embodiment;

FIG. 3 is a sectional view illustrating a second embodiment;

FIGS. 4A to 4E are schematic process diagrams for explaining the second embodiment;

FIG. 5 is a sectional view illustrating a third embodiment;

FIG. 6 is a sectional view illustrating a comparative example;

FIG. 7 is a schematic diagram of a configuration of a recording apparatus according to the embodiments;

FIGS. 8A and 8B are perspective views of a liquid discharging head according to the embodiments;

FIGS. 9A and 9B are perspective views of a discharging module according to the embodiments;

FIGS. 10A and 10B are plan views of an element substrate according to the embodiments; and

FIG. 11 is a perspective view illustrating a cross section of the element substrate and a cover plate according to the embodiment.

### DESCRIPTION OF THE EMBODIMENTS

The present invention will now be explained with reference to drawings. Although the embodiments described below may include specific descriptions for providing sufficient explanations of the present invention, such descriptions illustrate one example that is technically preferable, and are not intended to limit the scope of the present invention to any particular scope. Furthermore, in the present disclosure, a description such as “at least one selected from a group consisting of X, Y or Z” means any one of X, Y, Z, a combination of X and Y, a combination of X and Z, a combination of Y and Z, and a combination of X, Y, and Z.

The embodiments described below provide an ink jet recording apparatus in which liquid such as ink is circulated through a tank and a liquid discharging unit, but may have different configuration. For example, the embodiment may have a configuration in which a liquid discharging unit is provided with two tanks on an upstream side and a downstream side, respectively, and the ink inside pressure chambers is caused to move by passing the ink from one tank to the other, without circulating the ink.

Furthermore, the embodiments described below provide a recording apparatus including what is called a line head having a length corresponding to the width of a recording medium, but the present invention is also applicable to what is called a serial liquid discharging unit that performs recording by scanning across a recording medium. One example of such a serial liquid discharging unit includes a configuration having an element substrate for each of black ink and color inks, for example, but without limitation thereto. The recording apparatus may have a configuration in which a short line head, having a few element substrates disposed in such a manner that the nozzles each having a length shorter than the width of the recording medium overlap each other in a nozzle row direction, is scanned across the recording medium.

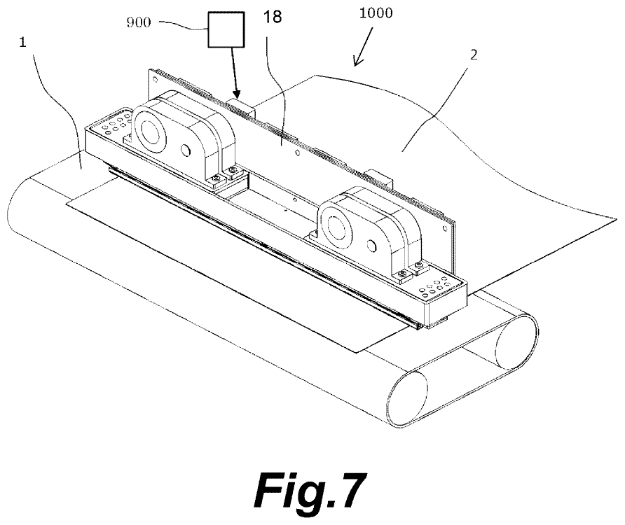

FIG. 7 illustrates a general configuration of an apparatus that performs recording by discharging liquid, particularly, an ink jet recording apparatus (hereinafter, referred to as a recording apparatus) 1000 that performs recording by discharging ink, in the embodiment. The recording apparatus 1000 is a line recording apparatus including a feeder unit 1 for feeding a recording medium 2, and a line liquid discharging head 18 disposed substantially perpendicularly to the direction for feeding the recording medium 2, and that performs continuous recording with one pass, while feeding a plurality of recording medium 2 successively or intermittently. The liquid discharging head 18 is connected to a liquid supplying unit that is a supplying channel for supplying liquid into the liquid discharging head 18. A control unit 900 that transmits power and discharge control signals to the liquid discharging head 18 is electrically connected to the liquid discharging head 18.

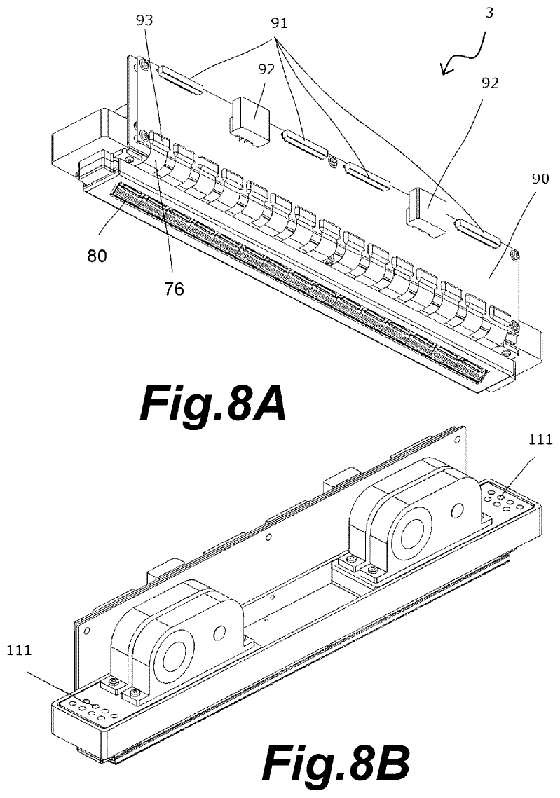

A configuration of the liquid discharging head 18 according to the embodiment will now be explained. FIGS. 8A and 8B are perspective views of the liquid discharging head 18. The liquid discharging head 18 is a line liquid discharging head having a plurality of (fifteen, in the embodiment) element substrates 80 disposed linearly (disposed serially). As illustrated in FIG. 8A, the liquid discharging head 18 includes a plurality of element substrates 80, and the element substrates 80 are electrically connected to signal input terminals 91 and power feeding terminals 92, via respective flexible wiring substrates 76 and electric wiring substrates 90. The signal input terminals 91 and the power feeding terminals 92 are electrically connected to the control unit 900 of the recording apparatus 1000. Discharge driving signals are input to the element substrates 80 via the signal input terminals 91, and the power required in discharging the liquid is supplied to the element substrates 80 via the power feeding terminals 92. As illustrated in FIG. 8B, liquid connectors 111 provided to ends of the liquid discharging head 18 are connected to a liquid supply system of the recording apparatus 1000. In this manner, ink is supplied from the supply system of the recording apparatus 1000 into the liquid discharging head 18, and ink having passed through the liquid discharging head 18 is collected into the supply system of the recording apparatus 1000. In the manner described above, the ink of each color can be circulated through the path inside the recording apparatus 1000 and the path inside the liquid discharging head 18.

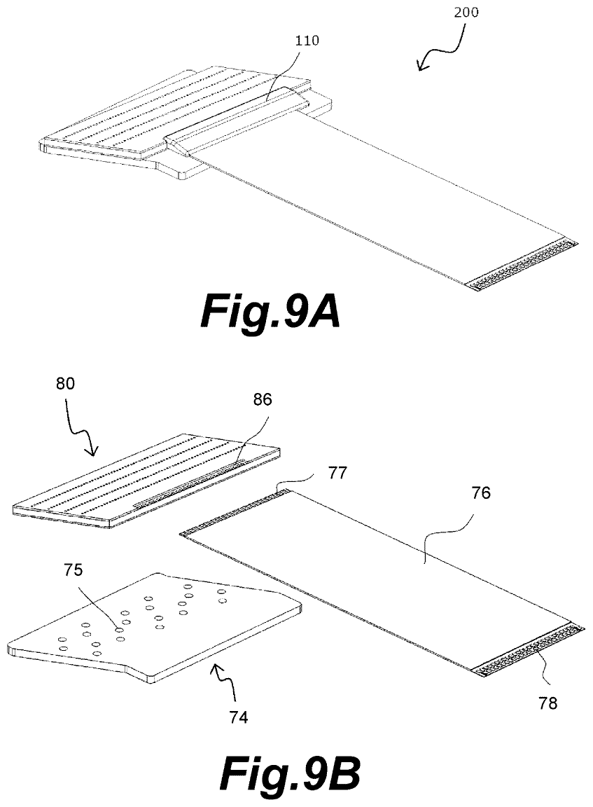

FIG. 9A is a perspective view, and FIG. 9B is an exploded view of one discharging module 200. As a method for manufacturing the discharging module 200, to begin with, the element substrate 80 and the flexible wiring substrate 76 are bonded, in advance, to a support member 74 having liquid passage ports 75. A terminal 86 of the element substrate 80 and a terminal 77 of the flexible wiring substrate 76 are then electrically connected to each other via wire bonding. The wire-bonded portion (electrically connected portion) is then covered and sealed by a sealing material 110. A terminal 78 of the flexible wiring substrate 76, the terminal 78 being positioned on the opposite side of the element substrate 80, is electrically connected to a connection terminal 93 of the electric wiring substrate 90 (see FIG. 8A). The support member 74 is a support body for supporting the element substrate 80, and also is a channel member fluidically connecting the element substrate 80 and the liquid connector 111. Preferably, the support member 74 has a high flatness so that the element substrate 80 can be bonded sufficiently reliably. As a material of the support member 74, alumina or resin material is preferable.

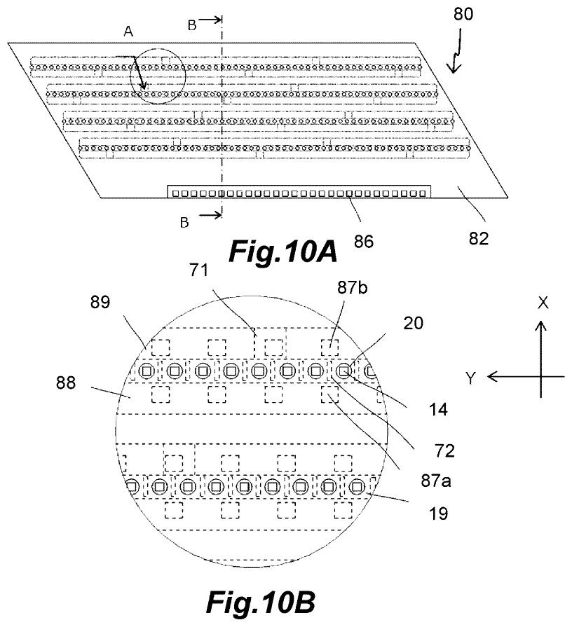

A configuration of the element substrate 80 in the embodiment will now be explained. FIG. 10A is a plan view of a surface on the side of the element substrate 80 with nozzles 20, and FIG. 10B is an enlarged view of a portion indicated as “A” in FIG. 10A. As illustrated in FIG. 10A, four rows of nozzles, each corresponding to one ink color, are provided to a channel forming member 82 of the element substrate 80. The direction along which the rows of nozzles including an arrangement of a plurality of nozzles 20 extend will be referred to as a “nozzle row direction”. The nozzle row direction is in parallel with a planar part of the element substrate 80. The nozzle row direction will be referred to as a Y direction (second direction), and a direction intersecting with the nozzle row direction and in parallel with the planar potion of the element substrate 80 will be referred to as an X direction (first direction). The direction perpendicular to the planar potion of the element substrate 80 will be referred to as a Z direction (third direction). In the embodiment, the Y direction, the X direction, and the Z direction are orthogonal to one another.

As illustrated in FIG. 10B, a piezoelectric element 14 for changing the pressure of the liquid is disposed at a position corresponding to each of the nozzles 20. Separator walls 72 define the pressure chambers 19 (cavities) internal of each of which has the piezoelectric element 14. The piezoelectric element 14 is electrically connected to the terminal 86 illustrated in FIG. 10A, by electric wiring (not illustrated) provided to the element substrate 80. The piezoelectric element 14 changes the pressure of the liquid by deforming in response to a pulse signal input from a control circuit of the recording apparatus 1000, via the electric wiring substrate 90 and flexible wiring substrate 76 (see FIGS. 8A and 8B). With this change in the pressure, the liquid is discharged from the nozzles 20. As illustrated in FIG. 10B, a liquid supplying channel 88 extends on one side, and a liquid collecting channel 89 extends on the other side of each of the nozzle rows. The liquid supplying channel 88 and the liquid collecting channel 89 are channels provided to the element substrate 80, extend along the nozzle row direction (Y direction), and are communicated with the pressure chambers 19 through supplying ports 87a and collecting ports 87b, respectively. The supplying ports 87a and the collecting ports 87b are aligned along the X directions.

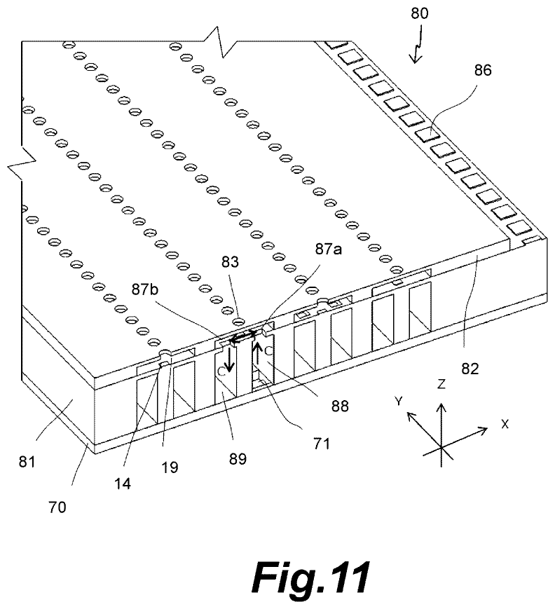

A flow of the liquid in the element substrate 80 will now be explained. FIG. 11 is a perspective view illustrating a cross section of the element substrate 80 and a cover plate 70 across the line B-B in FIG. 10A. The element substrate 80 is a lamination of a substrate 81 formed of Si and a channel forming member 82 formed of a photosensitive resin, and a cover plate 70 is bonded on the rear surface of the substrate 81. The piezoelectric element 14 is provided on one surface side of the substrate 81, and grooves forming the liquid supplying channel 88 and the liquid collecting channel 89 extending along nozzle row direction (Y direction) are provided on the rear surface side.

The liquid supplying channel 88 and the liquid collecting channel 89 formed by the substrate 81 and the cover plate 70 are connected to a common supplying channel and a common collecting channel, respectively, that are provided in the channel member, not illustrated, and there is a pressure difference between the liquid supplying channel 88 and the liquid collecting channel 89. While the liquid is being discharged from the plurality of nozzles 20 on the liquid discharging head 18 and performing recording, due to the pressure difference the liquid in the liquid supplying channel 88 in the substrate 81 at the position corresponding to the nozzles 20, which are not performing discharging operation, flows into the liquid collecting channel 89. This flow is a flow passing through the supplying ports 87a, the pressure chamber 19, and the collecting port 87b, and is indicated by the arrow C in FIG. 11.

With this flow, thickening ink resultant of evaporation through the nozzles 20, bubbles, or foreign substance inside the nozzles 20 or the pressure chambers 19 not performing the recording can be collected into the liquid collecting channel 89. Furthermore, thickening of the ink inside the nozzle 20 or the pressure chamber 19 can be suppressed. The liquid collected into the liquid collecting channel 89 is further collected through openings 71 on the cover plate 70, the liquid passage ports 75 on the support member 74 (see FIG. 9B), and passage ports, individual collecting channels, and the common collecting channel provided to the channel member, not illustrated, in the order described herein. Finally, the liquid is collected into a supplying path of the recording apparatus 1000.

The plurality of supplying ports 87a are communicated with the liquid supplying channel 88. The liquid supplying channel 88 is a common channel for supplying the liquid into the plurality of the supplying ports 87a. The plurality of collecting ports 87b are communicated with the liquid collecting channel 89. The liquid collecting channel 89 is a common channel for collecting the liquid from the plurality of the collecting ports 87b. The common channels with large openings (the liquid supplying channel 88, the liquid collecting channel 89) are formed in the substrate 81 by etching from the bottom surface, and the plurality of individual channels with small openings (the supplying ports 87a and the collecting ports 87b) are formed by etching from the top surface. By etching until the plurality of individual channels open through to the bottom surface of the common channel, the bottom surface of the common channel becomes penetrated, and the common channel and the plurality of individual channels together from through holes penetrating the substrate 81.

The liquid discharging head 18 is a member included in the recording apparatus 1000. The recording apparatus 1000 also includes a liquid storage for storing therein liquid to be supplied to the liquid discharging head 18, and a feeding mechanism for feeding a recording medium 2 on which recording is to be performed.

### First Embodiment

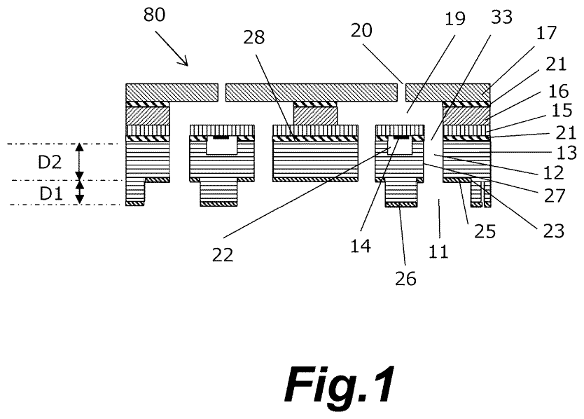

FIG. 1 is a sectional view of the element substrate 80 included in the liquid discharging head 18 according to a first embodiment. The element substrate 80 has a configuration in which a protection substrate 13 having a first channel 11 and a second channel 12, an actuator substrate 16 having the piezoelectric element 14 and a diaphragm 15, and a nozzle substrate 17 that are bonded to one another.

The actuator substrate 16 is made of silicon, for example, and has the plurality of pressure chambers 19. The diaphragm 15 of the actuator substrate 16 provides an upper wall of the pressure chambers 19, and defines the pressure chambers 19. The piezoelectric elements 14 are disposed on the diaphragm 15.

The nozzle substrate 17 is bonded to the actuator substrate 16. The nozzles 20 are formed on the top surface of the nozzle substrate 17. The nozzles 20 penetrate the nozzle substrate 17 from the surface facing the opposite side of the pressure chambers 19 into the pressure chambers 19. As a result of a change in the volume of the pressure chamber 19, the liquid accumulated inside the pressure chamber 19 is discharged through the nozzle 20.

The protection substrate 13 is made of silicon, for example. The protection substrate 13 is disposed in a manner covering the piezoelectric element 14, and is bonded to a surface of the actuator substrate 16 with an adhesive 21. The protection substrate 13 has recessed portions 22 on the surface facing a surface of the actuator substrate 16. Inside each of the recessed portions 22, corresponding one of a plurality of the piezoelectric elements 14 is housed.

The protection substrate 13 has the first channel 11 having an opening on a front surface 26 of the protection substrate 13, and the second channel 12 having an opening on the rear surface 28 of the protection substrate 13. An end of the second channel 12 on the opposite side of the rear surface 28 opens to the bottom surface 25 of the first channel 11. The second channel 12 is communicated with the pressure chamber 19 formed in the actuator substrate 16. The first channel 11 and the second channel 12 together form a channel passing through the protection substrate 13. The area of the bottom surface of the first channel 11 is larger than the area of the opening of the second channel 12. The bottom surface 25 of the first channel 11 is provided with a protection film 23, the etching rate of which is lower than Si etching. The etching rate of the material of the protection film 23 is lower than the etching rate of silicon that is the material of the protection substrate 13. With the protection film 23 provided, the bottom surface 25 of the first channel 11 has a flat surface having an average roughness Ra not more than 1.0 μm.

The element substrate 80 includes the protection substrate 13 that is a first substrate bonded to the actuator substrate 16 and the nozzle substrate 17 forming a second substrate. The protection substrate 13 that is the first substrate has a first channel 11 having a recessed shape and provided to the front surface 26 that is a first surface. The protection substrate 13 also has a plurality of second channels 12 that are provided to the rear surface 28 that that is a second surface that is on the opposite side of the first surface, and each of which has a recessed shape. The plurality of second channels 12 open to the bottom surface 25 of the first channel 11. The protection film 23 is provided to the bottom surface 25 of the first channel 11 in a part not having the openings of the plurality of respective second channels 12, and formed of a material different from the material of the protection substrate 13 that is a first substrate. Among the actuator substrate 16 and the nozzle substrate 17 forming the second substrate, the actuator substrate 16 is bonded to the rear surface 28 that is the second surface of the protection substrate 13 that is the first substrate. The nozzle substrate 17 forming the second substrate includes a plurality of nozzle 20 for discharging liquid and a plurality of pressure chambers 19 that are a plurality of liquid chambers that supplies liquid into the plurality of nozzles 20. The plurality of pressure chambers 19 are communicated with the plurality of the respective second channels 12 provided to the protection substrate 13 that is the first substrate. A plurality of energy generators that are a plurality of energy generators for discharging liquid from the plurality of respective nozzles 20, and corresponding to the plurality of respective pressure chambers 19 are provided. In the first embodiment, each of the energy generators includes the diaphragm 15 forming a part of a wall surface of the pressure chamber 19, and the piezoelectric element 14 provided to the diaphragm 15. In the first embodiment, the length (depth) D1 of the first channel 11 is shorter (shallower) than the length (depth) D2 of the second channel 12, in the thickness direction of the protection substrate 13 that is the first substrate.

Because the protection film 23 is not provided to a side wall 27 of the second channel 12, it is possible to suppress a reduction of the cross-sectional area of the second channel 12, and to suppress an increase in the channel resistance. Furthermore, because the protection film 23 is provided to the bottom surface 25 of the first channel 11, it is possible to suppress roughening of the bottom surface 25 of the first channel 11.

As the protection film 23 having a low etching rate for Si etching, it is possible to use a resin film such as resist. Such a configuration, too, has an effect of suppressing a roughening of the bottom surface 25 of the first channel 11. With a resist resin film, however, it is necessary to remove the film in a subsequent flow.

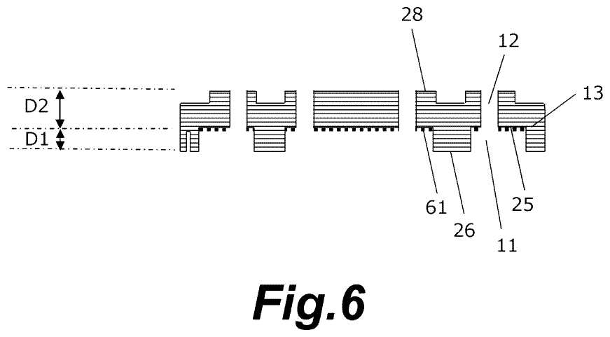

FIG. 6 is a schematic illustrating a comparative example provided for the purpose of comparison with the first embodiment. As illustrated in FIG. 6, let us now consider a configuration in which the bottom surface 25 of the first channel 11 does not have the protection film 23 having a low etching rate. After the first channel 11 is formed by etching from the front surface 26 of the protection substrate 13, the second channel 12 is formed by etching from the rear surface 28 of the protection substrate 13, and penetrates the bottom surface 25 of the first channel 11. At this time, a phenomenon in which the gas for etching Si flows along the bottom surface 25 of the first channel 11 and causes the bottom surface 25 of the first channel 11 to roughen may take place. This roughness 61 may cause a generation of foreign substance during the subsequent process, or cause a deterioration in the yield or in the discharging function.

The roughness 61 becomes more prominent when the ratio between the depth D1 of the first channel 11 and depth D2 of the second channel 12 is in a relation of D1/D2<1. In other words, when the depth D2 of the second channel 12 becomes greater, a longer over-etching time is required to absorb the difference in the etching rate across the entire wafer surface. Therefore, the part with a higher rate penetrates at an earlier stage, and the etching gas flows toward the first channel 11, so that the bottom surface 25 of the first channel 11 of the part is more likely to have the roughness 61. Once the roughness 61 is formed, pieces of Si may become detached and turned into foreign substance in the subsequent process. Furthermore, pools of bubbles may be formed on the roughness 61 as the liquid is discharged, and cause the discharging function to deteriorate.

By contrast, in the first embodiment, because the bottom surface 25 of the first channel 11 has a flat surface, with roughening suppressed, it is possible to suppress formation of foreign substance or pools of bubbles at the time when the liquid is discharged.

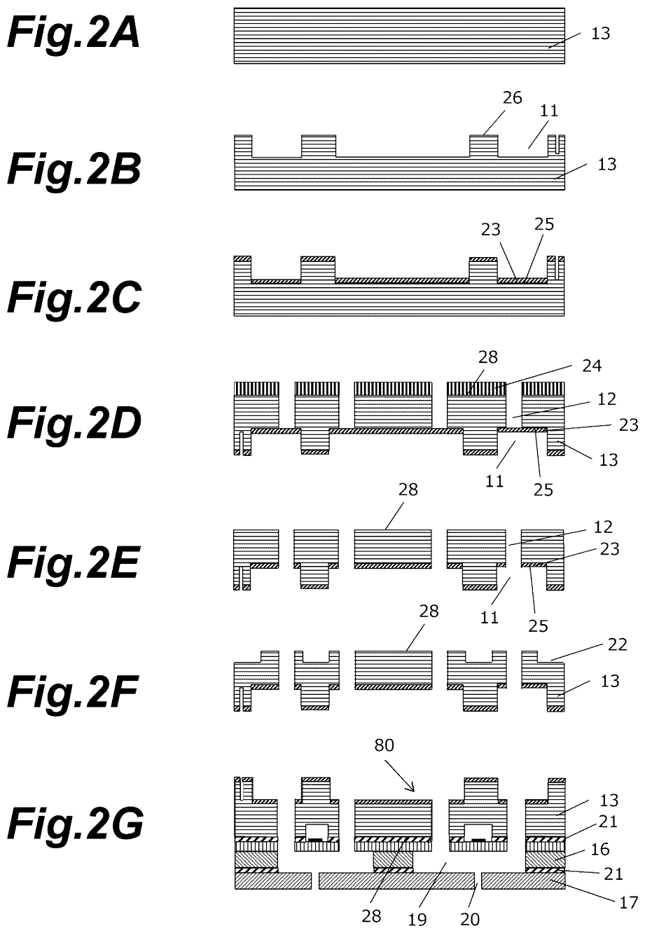

A method of manufacturing the element substrate 80 in the liquid discharging head 18 according to the first embodiment will now be explained with reference to FIGS. 2A to 2G.

In the first embodiment, dry etching is used in manufacturing the element substrate 80. Dry etching is a technique for introducing a reactant gas into a processing chamber and turning the gas into a plasma, and achieving a predetermine shape on a target surface of a substrate, by etching using the reactant gas plasma. Specifically, using an electrostatic chuck, for example, a substrate is fixed to a lower electrode inside a processing chamber, and a reactant gas is supplied from extremely small holes of an upper electrode with a high-frequency power source connected between the upper electrode and the lower electrode. The supplied reactant gas is turned into a plasma, between the upper electrode and the lower electrode, and etches the substrate into a predetermined shape. As a method of dry etching, reactive-ion etching using etching gas may be used, for example. Reactive-ion etching is suitable for achieving a vertical through hole. Reactive-ion etching is preferably used in forming liquid supplying ports that are through holes, in a substrate of a liquid discharging head, a typical example of which is an ink jet head.

To begin with, as illustrated in FIG. 2A, a silicon substrate to be turned into the protection substrate 13 and having a thickness of 600 μm is prepared.

The first channel 11 having a recessed shape is then formed from the front surface 26 of the protection substrate 13, as illustrated in FIG. 2B. Using a novolac-based photoresist as the etching mask (not illustrated), a pattern of the opening is formed by exposing and developing the photoresist. By performing Si dry etching using this mask, a recessed portion to be the first channel 11 is formed a halfway down into the protection substrate 13 in the thickness direction. The etching depth is set to 200 μm, and an etching technique what is called a Bosh process, which uses SF₆ gas in an etching step and C₄F₈ gas in a coating step, is used. However, the first channel 11 may be formed using any technique other than the Bosh process.

The etching mask is then removed, and the protection film 23 is formed on the bottom surface 25 of the first channel 11, with a material having an etching rate lower than Si that is the material of the protection substrate 13, from the side of the front surface 26 of the protection substrate 13, as illustrated in FIG. 2C. In the first embodiment, a silicon oxide film is formed using plasma CVD (P-CVD), as the protection film 23. As to the etching rate, representing the etching rate of Si that is the material of the protection substrate 13 as one, a material having an etching rate not higher than 0.01, more preferably, not higher than 0.005 is used in forming the protection film. An oxide film is a film that is barely etched. The film thickness is set to 200 nm. This setting enables subsequent etching of the second channel 12 without penetrating the substrate, even if the substrate is over-etched, in consideration of the rate distribution. A technique used in forming the protection film 23 is not limited to the plasma CVD. Any technique may be used, as along as a film having a film thickness not less than a thickness capable of tolerating etching at an etching rate not higher than a certain etching rate can be formed using an atomic layer deposition (ALD).

The plurality of second channels 12 each having a recessed shape are then formed in a manner connecting to the bottom surface 25 of the first channel 11, by performing Si dry etching, from the rear surface 28 of the protection substrate 13, using the etching mask 24 as a mask, as illustrated in FIG. 2D. At this time, as the conditions of the Si etching, a technique what is called a Bosh process, which uses an etching step and a coating step, is used.

The bottom surface 25 of the first channel 11 is then subjected to oxide-film-etching, so as to remove the protection film 23 from the part where the second channel 12 is to be connected, as illustrated in FIG. 2E, and opening of the plurality of second channels 12 are then formed on the bottom surface 25 of the first channel 11. In this manner, the first channel 11 and the second channels 12 are communicated with each other. As the conditions of the subsequent oxide film etching, a gas mixture of C₄F₈ gas, CF₄ gas, and Ar gas is used. As an example of the condition of the oxide film etching, the gas pressure is controlled to 0.3 Pa, the gas flow rate is controlled to 500 sccm, the coil power is controlled to 1500 W, and the platen power is controlled to 400 W. Under these conditions, although an oxide film is etched, Si is barely etched.

The etching mask 24 is then removed, and recessed portions 22 are then formed from the rear surface 28 of the protection substrate 13, as illustrated in FIG. 2F. The recessed portions 22 provide covering for the piezoelectric element 14. Another etching mask (not illustrated) is patterned on the bottom surface of the etching mask 24 described above, in advance. After the etching mask 24 is removed, the recessed portions 22 are formed by Si etching. The resist mask may also be formed as a dry film, and the recessed portions 22 may be formed by performing Si dry etching.

The plurality of nozzles 20, and the plurality of pressure chambers 19 that are a plurality of individual channels for supplying liquid of the plurality of respective nozzles 20 and connected to the respective second channels 12 in the protection substrate 13 are then formed, and the actuator substrate 16 and the nozzle substrate 17 are then prepared. As illustrated in FIG. 2G, the actuator substrate 16 and the nozzle substrate 17 are bonded to the rear surface 28 that is the second surface of the protection substrate 13, using an adhesive 21. As a technique for applying the adhesive, a method for spin-coating the adhesive onto the dry film and transferring the adhesive onto the protection substrate 13 is used. However, the method for applying adhesive is not limited thereto, and it is also possible to use screen printing or photolithographic pattering, using a photosensitive adhesive.

Through the process described above, the element substrate 80 for the liquid discharging head 18 according to the first embodiment is manufactured.

### Second Embodiment

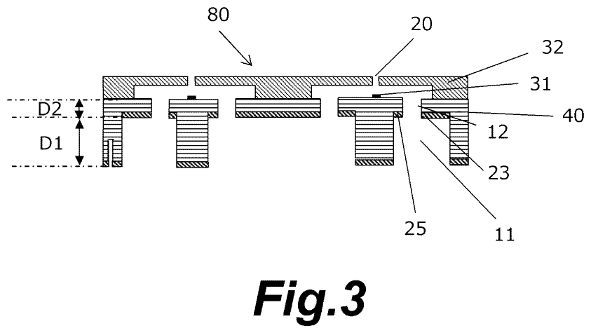

A second embodiment will now be explained, by referring to the cross-sectional view in FIG. 3. The element substrate 80 according to the second embodiment includes a heat generator 31 as means for generating energy used in discharging the liquid. The heat generator 31 is a thermoelectric conversion element that generates thermal energy for causing film evaporation of the liquid, by conducting electricity. After forming the first channel 11 and the second channels 12 in a substrate 40 provided with the heat generator 31, an orifice plate 32 is provided to form the nozzles 20 for discharging liquid. On the bottom surface 25 of the first channel 11, the protection film 23 having a low etching rate for Si etching is then formed. In other words, the protection film 23 is a film having a high etching selectivity. As the protection film 23, a silicon oxide film is formed using P-CVD.

In relation to a ratio between the depth D1 of the first channel 11 and the depth D2 of the second channel 12, it is preferable to set the second channels 12 shorter (shallower) so as to reduce the channel resistance near the heat generator 31 and improve refilling performance. In the second embodiment, the length (depth) D1 of the first channel 11 is longer (deeper) than the length (depth) D2 of the second channel 12 in the thickness direction of the substrate 40 that is the first substrate. When the ratio of the depth satisfies D1/D2>1, the roughness 61 explained in FIG. 6 is less likely to be formed. Furthermore, because the protection film 23 is not formed on the side walls of the second channels 12, it is possible to suppress a reduction in the cross-sectional area of the second channel 12, so that an increase in the channel resistance can be suppressed. Furthermore, because the protection film 23 is formed on the bottom surface 25 of the first channel 11, it is possible to suppress roughening of the bottom surface 25 of the first channel 11. In this manner, it is possible to suppress formation of foreign substance or pools of bubbles, and to achieve the element substrate 80 with higher stable discharging performance.

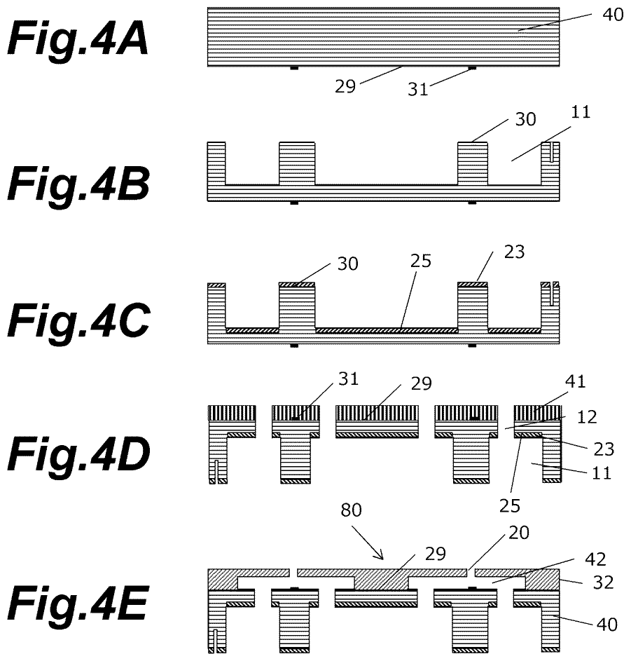

A method of manufacturing the element substrate 80 included in the liquid discharging head 18 according to the second embodiment will now be explained with reference to FIGS. 4A to 4E.

To begin with, the substrate 40 that is a silicon single crystal substrate having an ingot pull-out orientation of <100>, with the front surface 29 provided with the heat generator 31 and wiring (not illustrated) for driving the heat generator 31 as illustrated in FIG. 4A, is prepared. The substrate thickness is set to 600 μm.

An etching mask (not illustrated) is patterned on a rear surface 30 that is on the opposite side of the front surface 29 provided with the heat generator 31, as illustrated in FIG. 4B, and the first channel 11 is formed by dry etching. As the etching mask, patterning of a novolac-based positive photoresist is carried out using photolithography. The depth of the first channel 11 is set to 500 μm.

The protection film 23 having a lower etching rate for Si etching is then formed on the bottom surface 25 of the first channel 11 as illustrated in FIG. 4C. At this time, an oxide film is formed by P-CVD as the protection film 23.

Patterning of the etching mask 41 for forming the second channels 12 from the front surface 29 provided with the heat generator 31 is then carried out, as illustrated in FIG. 4D, and the second channels 12 are formed by Si dry etching. The protection film 23 on the bottom surface 25 of the first channel 11 is then etched from the part where the second channel 12 is to open, so as to communicate with the first channel 11 to the second channel 12.

The element substrate 80 is then achieved by providing an orifice plate 32 having liquid channels 42 and the nozzles 20 on the front surface 29 of the substrate 40, as illustrated in FIG. 4E. As a method for providing the orifice plate 32 on the substrate 40 having the first channel 11 and the second channels 12 communicated with each other, a method using a support and photosensitive resin may be used. The photosensitive resin is formed on the support, and the photosensitive resin is installed in a manner straddling across the opening on the substrate 40. Examples of the support include a film, glass, or silicon wafer, for example. Because the support needs to be peeled off later, a film is preferably used. Examples of the support include a polyethylene terephthalate (PET) film, a polyimide film, and polyamide film. Furthermore, it is also possible to use a film provided with anti-sticking treatment so as to make it easier to peel off the film.

As the photosensitive resin, a first photosensitive resin for forming the liquid channels 42 and a second photosensitive resin to be turned into the orifice plate 32 are used. The orifice plate 32 can be formed by forming a pattern of the first photosensitive resin on the support; then forming the second photosensitive resin on the first photosensitive resin; providing through holes to be turned into the nozzles 20 into the second photosensitive resin; and by removing the first photosensitive resin. As the first photosensitive resin, epoxy resin dissolving into organic solvent may be used. In this manner, the first photosensitive resin can be removed by using organic solvent. Furthermore, the first photosensitive resin may be acrylic resin or urethane resin. As a method for patterning the first photosensitive resin, it is possible to use a transfer method, examples of which include spin coating, slit coating, laminating, and pressing.

### Third Embodiment

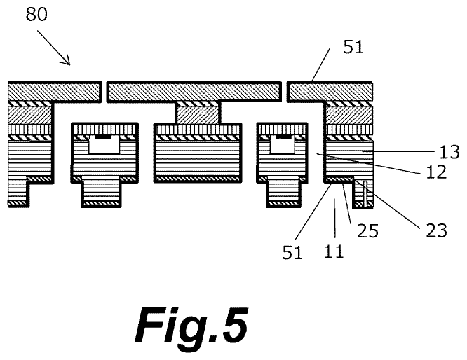

FIG. 5 is a cross-sectional view of the element substrate 80 according to the third embodiment. Differences with respect to the first embodiment and the second embodiment will be mainly explained. As illustrated in FIG. 5, a Si protection film 51 is formed on the element substrate 80 fabricated in the first embodiment. The Si protection film 51 is formed using atomic layer deposition (ALD), and at least one of the materials selected from a group of tantalum oxide, titanium oxide, hafnium oxide, or zirconium oxide is formed continuously.

In the third embodiment, a tantalum oxide film used as the Si protection film 51, and the film thickness is set to 0.1 μ(100 nm). With a rough bottom surface 25 of the first channel 11 where the first channel 11 and the second channel 12 communicate with each other, an Si protection film may peel off even if such an Si protection film is formed on the bottom surface 25 of the first channel 11. In the third embodiment, because the protection film 23 is formed on the bottom surface 25 of the first channel 11 where the Si protection film 51 is formed, there is no roughness, and it is possible to reduce the chances of the Si protection film 51 from peeling off. In this manner, it is possible to improve the reliability of the element substrate 80 and the liquid discharging head 18.

According to the present disclosure, it is possible to suppress roughening of the bottom surface of a channel while the channel is being formed by dry-etching the substrate from respective surfaces of the substrate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-001728, filed on Jan. 10, 2024, which is hereby incorporated by reference herein in its entirety.

What is claimed is:

1. A method of manufacturing a liquid discharging head including a substrate having a channel for liquid, the method comprising:
forming a first channel having a recessed shape by dry-etching the substrate from a first surface thereof;
forming a protection film by using a material, which is different from a material of the substrate, on a bottom surface of the first channel;
forming a plurality of second channels each having a recessed shape by dry-etching the substrate from a second surface that is on an opposite side to the first surface so as to be connected to the bottom surface of the first channel; and
opening the plurality of second channels through to the bottom surface of the first channel by removing the protection film from parts of the bottom surface of the first channel, the parts being parts to which the plurality of second channels are to be connected respectively, by dry etching from a second surface side, wherein
an etching rate of a material of the protection film is lower than an etching rate of a material of the substrate during the dry-etching for forming the plurality of second channels in the substrate.

2. The method of manufacturing a liquid discharging head according to claim 1, with the substrate being referred as a first substrate, the method further comprising:
forming, in a second substrate,
a plurality of nozzles for discharging liquid;
a plurality of liquid chambers via which the liquid is supplied into the plurality of nozzles respectively and which are communicated with the plurality of second channels in the substrate respectively; and
a plurality of energy generators which correspond to the plurality of liquid chambers respectively and which generate energy for causing the plurality of respective nozzles to discharge the liquid; and
bonding the second substrate onto the second surface of the first substrate.

3. The method of manufacturing a liquid discharging head according to claim 2, wherein each of the energy generators includes a diaphragm forming a part of a wall surface of corresponding one of the liquid chambers, and a piezoelectric element provided to the diaphragm.

4. The method of manufacturing a liquid discharging head according to claim 3, wherein a length of the first channel is shorter than a length of the second channel in a thickness direction of the first substrate.

5. The method of manufacturing a liquid discharging head according to claim 2, wherein the energy generator includes a thermoelectric conversion element that generates thermal energy for causing film boiling of the liquid by conducting electricity.

6. The method of manufacturing a liquid discharging head according to claim 5, wherein a length of the first channel is longer than a length of the second channel in a thickness direction of the first substrate.

7. The method of manufacturing a liquid discharging head according to claim 1, wherein, in a case where the etching rate of the material of the substrate is represented as one, the etching rate of the material of the protection film is not higher than 0.01.

8. The method of manufacturing a liquid discharging head according to claim 1, wherein the material of the substrate is silicon, and the protection film is a silicon oxide film.

9. The method of manufacturing a liquid discharging head according to claim 1, wherein the material of the substrate is silicon, and the protection film is a resin film.

10. The method of manufacturing a liquid discharging head according to claim 1, wherein, in the forming of the protection film, the protection film is formed using plasma chemical vapor deposition (CVD) or atomic layer deposition.

11. A liquid discharging head comprising:
a substrate formed of silicon and having a first surface and a second surface on an opposite side to the first surface;
a first channel for liquid provided to the first surface of the substrate and having a recessed shape;
a plurality of second channels for liquid provided to the second surface of the substrate, each having a recessed shape, and opening to a bottom surface of the first channel; and
a protection film provided to the bottom surface of the first channel in a part not having openings of the plurality of respective second channels and formed of a material different from a material of the substrate, wherein
in relation to etching of silicon forming the substrate, an etching rate of a material of the protection film is lower than an etching rate of the silicon forming the substrate.

12. The liquid discharging head according to claim 11, with the substrate as being referred as a first substrate, the liquid discharging head further comprising a second substrate bonded to the second surface of the first substrate, wherein
the second substrate includes:
a plurality of nozzles for discharging liquid;
a plurality of liquid chambers via which the liquid is supplied into the plurality of nozzles respectively and which are communicated with the plurality of second channels in the substrate respectively; and
a plurality of energy generators that correspond to the plurality of liquid chambers respectively and which generate energy for causing the plurality of respective nozzles to discharge the liquid.

13. The liquid discharging head according to claim 12, wherein each of the energy generators includes a diaphragm forming a part of a wall surface of corresponding one of the liquid chambers and a piezoelectric element provided to the diaphragm.

14. The liquid discharging head according to claim 13, wherein a length of the first channel of the first substrate is shorter than a length of the second channel in a thickness direction of the first substrate.

15. The liquid discharging head according to claim 12, wherein each of the energy generators includes a thermoelectric conversion element that generates thermal energy for causing film boiling of the liquid by conducting electricity.

16. The liquid discharging head according to claim 15, wherein a length of the first channel is longer than a length of the second channel in a thickness direction of the first substrate.

17. The liquid discharging head according to claim 11, wherein the protection film is not provided to a side wall of the second channels.

18. The liquid discharging head according to claim 11, wherein the protection film is a silicon oxide film.

19. The liquid discharging head according to claim 11, wherein the protection film is a resin film.

20. The liquid discharging head according to claim 11, wherein an average roughness of the bottom surface provided with the protection film of the first channel is not more than 1.0 μm.
